(19) United States
(12) Patent Application Publication
(10) Pub. No.: US 2006/0275566 A1
(43) Pub. Date: Dec. 7, 2006

(54) Water-soluble, liquid-containing pouch

(76) Inventors: Francesco de Buzzaccarini, Breendonk (BE); Steven Jozef Louis Coosemans, Kampenhout (BE); Lorenzo Matteo Pierre Gualco, Brussels (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/444,086

(22) Filed: May 31, 2006

(30) Foreign Application Priority Data
Jun. 1, 2005 (EP) 05076277.2

(51) Int. Cl. B32B 27/32

(52) U.S. Cl. 428/35.2

(57) ABSTRACT

A water-soluble pouch containing a liquid composition wherein the water-soluble pouch is made from a film comprising a co-polymer of vinyl alcohol and a carboxylic acid, wherein the liquid composition contained within said pouch comprises at least one dissolved ionic component selected from the group consisting of carboxylates, phosphonates, and mixtures thereof, and from 5% to 15% by weight of the liquid composition of water, and wherein said pouch is processed using a vacuum formed, horizontal form-fill-seal process.

### TECHNICAL FIELD OF THE INVENTION

The present invention relates to water-soluble, liquid-containing pouches, especially to pouches containing cleaning liquids such as detergents and hard surface cleaners. More specifically, the invention is directed to water-soluble pouches which exhibit improved compatibility when used in combination with selected levels of water and ionic components selected from the group consisting of carboxylates, phosphonates, and mixtures thereof.

### BACKGROUND OF THE INVENTION

Liquid-filled pouches are known as a convenient form of packaging consumer products as well as industrial products. The liquid can be provided in pre-measured quantities intended for use as “unit doses”. The film enveloping the liquid product, which forms the wall of the pouch, is soluble in water. A particularly suitable water-soluble film for this purpose is made from polyvinyl alcohol, and, in this context, this invention is particularly suited to packaging unit doses of liquid detergent. Commonly known water-soluble pouches are generally formed by using either a vertical form-fill-seal (VFFS) or horizontal form-fill-seal (HFFS) processes or by directly thermoforming water soluble envelopes.

Liquid products have been packaged in water-soluble films wherein the film is made from a water-soluble co-polymer comprising vinyl alcohol and carboxylic acid groups. However most of such water-soluble films exhibit poor compatibility when used in combination with compositions packed therein and comprising dissolved ionic components selected from the group consisting of carboxylates, phosphonates, and mixtures thereof. Such ionic components are desirable in liquid detergents as they generally act as builders or chelants. The aforementioned incompatibility translates into a substantial solubility loss of water-soluble pouches made from a film comprising a co-polymer of vinyl alcohol and a carboxylic acid. This solubility loss which is particularly pronounced upon prolonged storage of the water-soluble pouches, can lead to water-soluble film polymeric residues on fabric after the wash.

It is believed that the insolubilization phenomenon is due to the undesirable formation of lactone rings in and/or on the water-soluble film. The lactone formation which already takes place in the film comprising a co-polymer of vinyl alcohol and a carboxylic acid per se, is particularly enhanced when the composition packed within the pouch comprises dissolved ionic components. It is thought that the presence of such dissolved ionic components favourizes exchange between the counter-ion associated with the carboxylate groups in the film and hydrogen ions in the liquid composition, and thus facilitates the lactone formation. It has further surprisingly been observed that the additional amount of water, which is generally needed in the detergent composition to stably dissolve these ionic components, detrimentally exacerbates the effect of ionic components on the solubility of the water-soluble pouches made from a film comprising a co-polymer of vinyl alcohol and a carboxylic acid.

WO 01/79417 discloses a water-soluble package formed from a polymeric film, containing a non-aqueous liquid composition comprising an ionic ingredient and an excess of a stabilizing compound which is allegedly effective for reducing the formation of lactones within the film.

U.S. Pat. No. 6,185,410 describes a pouch made of a water-soluble film, containing a liquid composition comprising a solid builder/chelant and an anionic surfactant.

WO 2004/085586 discloses a water-soluble pouch containing a liquid comprising dissolved ionic components selected from the group of carboxylates, phosphonates and mixtures thereof, and wherein the pouch is manufactured from a water-soluble film which has been specifically modified.

Although the systems described in the prior art provide solutions for achieving improved compatibility of water-soluble pouches with ionic components, there is still a need for simpler and cheaper alternative systems.

It is therefore an objective of the present invention to provide a water-soluble liquid-containing pouch which exhibits excellent compatibility with dissolved ionic components selected from the group consisting of carboxylates, phosphonates, and mixtures thereof, whilst ensuring excellent stability for said dissolved ionic components and therefore providing improved water solubility of the liquid-containing pouch upon prolonged storage.

It has now been found that this objective can be met by providing a liquid-containing water-soluble pouch comprising dissolved ionic components selected from the group consisting of carboxylates, phosphonates, and mixtures thereof, wherein said pouch is made by using a horizontal form-fill-seal process (HFFS) and comprises a liquid composition having a carefully selected level of water.

Advantageously, the water-soluble liquid-containing pouch according to the present invention provides enhanced dissolution and disintegration profiles even after prolonged storage. Additionally, as the water-soluble pouches of the instant invention provide stable dissolution of the ionic components, the latter may perform their function with a significant improvement and fewer amounts of such components may be required.

A further advantage of the water-soluble pouches according to the present invention is that they may be manufactured using commercially available water-soluble films without any further modifications required.

### SUMMARY OF THE INVENTION

The present invention encompasses a water-soluble pouch containing a liquid composition wherein the water-soluble pouch is made from a film comprising a co-polymer of vinyl alcohol and a carboxylic acid, wherein the liquid composition contained within said pouch comprises at least one dissolved ionic component selected from the group consisting of carboxylates, phosphonates and mixtures thereof, and from 5% to 15% by weight of the liquid composition of water, and wherein said pouch is processed using a vacuum formed, horizontal form-fill-seal process.

In another embodiment, the present invention encompasses a process for making a water-soluble pouch having improved water-solubility upon storage, wherein the process comprises the steps of (a) formulating a liquid composition comprising at least one dissolved ionic component selected from the group consisting of carboxylates, phosphonates and mixtures thereof, and from 5% to 15% by weight of the liquid composition of water, and (b) processing a film comprising a co-polymer of vinyl alcohol and a carboxylic acid into a water-soluble pouch containing the liquid composition using a vacuum formed, horizontal form-fill-seal process.

### DETAILED DESCRIPTION OF THE INVENTION

Water-Soluble Film

According to the present invention, the water-soluble film comprises a co-polymer of vinyl alcohol and a carboxylic acid.

Preferably, the level of the co-polymer in the film material, is at least 60% by weight of the film. The polymer can have any weight average molecular weight, preferably from 1000 daltons to 1,000,000 daltons, more preferably from 10,000 daltons to 300,000 daltons, even more preferably from 15,000 daltons to 200,000 daltons, most preferably from 20,000 daltons to 150,000 daltons.

Preferably, the co-polymer present in the film is from 60% to 98% hydrolysed, more preferably 80% to 95% hydrolysed, to improve the dissolution of the material.

In a highly preferred execution, the co-polymer comprises from 0.1 mol % to 30 mol %, preferably from 1 mol % to 6 mol %, of said carboxylic acid.

The water-soluble film of the present invention may further comprise additional co-monomers. Suitable additional co-monomers include sulphonates and ethoxylates. An example of preferred sulphonic acid is 2-acrylamido-2-methyl-1-propane sulphonic acid (AMPS).

A suitable water-soluble film for use in the context of the present invention is commercially available under tradename M8630™ from Mono-Sol of Indiana, US.

The water-soluble film herein may also comprise ingredients other than the polymer or polymer material. For example, it may be beneficial to add plasticisers, for example glycerol, ethylene glycol, diethyleneglycol, propane diol, 2-methyl-1,3-propane diol, sorbitol and mixtures thereof, additional water, disintegrating aids, fillers, anti-foaming agents, emulsifying/dispersing agents, and/or antiblocking agents. It may be useful that the pouch or water-soluble film itself comprises a detergent additive to be delivered to the wash water, for example organic polymeric soil release agents, dispersants, dye transfer inhibitors. Optionally the surface of the film of the pouch may be dusted with fine powder to reduce the coefficient of friction. Sodium aluminosilicate, silica, talc and amylose are examples of suitable fine powders.

Liquid Composition

The term “liquid” is used herein to broadly include, for example, mixtures, solutions, dispersions and emulsions, although homogeneous liquids are most preferred. The liquid may have from low to very high viscosities including gels and pastes. The preferred viscosity may be up to 10,000 mPa·s, but it is more preferably from 100 to 3000 mPa·s, and most preferably from 300 to 1500 mPa·s when measured at 20 sec-1 and 21° C. The liquid may contain active ingredients suitable for various applications. Examples of such applications are domestic and consumer products, e.g. laundry cleaning and treatment, dish and hard surface cleaning, shampoo, bath additives; agrochemicals, e.g. pesticides, herbicides, fungicides, insecticides; industrial chemicals, e.g. materials used in construction industries, materials used in photography, printing and textile industries; chemicals for treating water, e.g. swimming pools, water heating systems, sewage and drainage systems; health and beauty care products, e.g. pharmaceutical and cosmetic applications. Particularly preferred liquids are suitable for use as liquid detergents in the cleaning of clothes, dishes, and other household surfaces.

The liquid composition preferably has a density of 0.8 kg/l to 1.3 kg/l, preferably about 1.0 to 1.1 kg/l. The liquid composition can be made by any method and can have any viscosity, typically depending on its ingredients. The viscosity may be controlled, if desired, by using various viscosity modifiers such as hydrogenated castor oil and/or solvents. Hydrogenated castor oil is commercially available as Thixcin®. Suitable solvents are described in more detail below.

It is preferred that the liquid compositions of the present invention are homogeneous solutions and, in particular, that the ionic components are dissolved in the homogeneous liquid.

The liquid of the present invention preferably has a pH of less than 9, preferably less than 8, when measured by dissolving the liquid to a level of 1% in demineralized water.

Ionic Components

The liquid compositions of the present invention comprise at least one dissolved ionic component selected from the group consisting of carboxylates, phosphonates, and mixtures thereof. Such ionic components may be suitable as builder/chelant actives used for binding metal ions in aqueous solutions.

In one execution of the present invention, the ionic component is a carboxylate, preferably a carboxylate builder, even more preferably a polycarboxylate builder. The term carboxylate as used herein encompasses the acid form of the salt and also encompasses “polycarboxylate” which refers to compounds having a plurality of carboxylate groups, preferably at least three carboxylates. Suitable polycarboxylate builder can preferably be added to the composition in acid form, but can also be added in the form of a neutralized salt. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al, U.S. Pat. No. 3,635,830, issued Jan. 18, 1972. See also “TMS/TDS” builders of U.S. Pat. No. 4,663,071, issued to Bush et al, on May 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability. Oxydisuccinates are also especially useful in such compositions and combinations.

Also suitable in the liquid detergent compositions of the present invention are the 3,3-dicarboxy-4-oxa-1,6-hexanedioates and the related compounds disclosed in U.S. Pat. No. 4,566,984, Bush, issued Jan. 28, 1986. Useful succinic acid builders include the C₅-C₂₀ alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in EP-A-0 200 263, published Nov. 5, 1986.

Specific examples of nitrogen-containing, phosphor-free aminocarboxylates include ethylene diamine disuccinic acid and salts thereof (ethylene diamine disuccinates, EDDS), ethylene diamine tetraacetic acid and salts thereof (ethylene diamine tetraacetates, EDTA), and diethylene triamine penta acetic acid and salts thereof (diethylene triamine penta acetates, DTPA).

Other suitable polycarboxylates are disclosed in U.S. Pat. No. 4,144,226, Crutchfield et al, issued Mar. 13, 1979 and in U.S. Pat. No. 3,308,067, Diehl, issued Mar. 7, 1967. See also Diehl U.S. Pat. No. 3,723,322. Such materials include the water-soluble salts of homo- and copolymers of aliphatic carboxylic acids such as maleic acid, itaconic acid, mesaconic acid, fumaric acid, aconitic acid, citraconic acid and methylenemalonic acid.

In another execution of the present invention, the ionic component is a phosphonate component. The term phosphonate as used herein encompasses the acid form of the salt. Suitable phosphonates for use in the present invention may be selected from the group of inorganic and organic phosphonates.

In a preferred embodiment, the phosphonate is selected from organic phosphonates. Examples of suitable organic phosphonates for use herein are amino alkylene poly(alkylene phosphonates), alkali metal ethane 1-hydroxy bisphosphonates and nitrilo trimethylene phosphonates. Preferred organic phosphonates for use herein are diethylene triamine penta(methylene phosphonate), ethylene diamine tri(methylene phosphonate)hexamethylene diamine tetra(methylene phosphonate) and hydroxy-ethylene 1,1 diphosphonate (HEDP). In the context of the present invention, HEDP is highly preferred.

Preferably, said at least one ionic component may be incorporated at a level of from 0.2% to 4.0%, preferably from 0.5% to 3.0%, more preferably from 0.5% to 2.0% by weight of the liquid composition.

Water Content

Although the liquid compositions of the present invention are concentrated compositions, they still contain some amount of water.

The liquid composition contained within the water-soluble liquid-containing pouches according to the present invention shall, as a first essential requirement, comprise, with increasing preference in the order given, from 5%, 6%, 7%, 8%, 9% to, with increasing preference in the order given, 15%, 14%, 13%, 12%, 11%, 10% by weight of the liquid composition, of water.

More specifically, the liquid composition contained within the water-soluble liquid-containing pouch according to the present invention, shall comprise from 5% to 15%, preferably from 6% to 12%, more preferably from 7% to 10%, most preferably from 8% to 10% by weight of the liquid composition, of water.

It has been surprisingly found that when the water content of the liquid composition is maintained within the range of from 5% to 15%, preferably from 6% to 12%, more preferably from 7% to 10%, most preferably from 8% to 10% by weight of the liquid composition, an optimized and stable dissolution of the ionic components selected from the group consisting of carboxylates, phosphonates, and mixtures thereof is obtained.

Horizontal Form-Fill-Seal Process

As a second essential requirement, the water-soluble liquid-containing pouches according to the present invention shall be processed using a vacuum formed, horizontal form-fill-seal process (HFFS).

Pouches according to the present invention may be processed according to any of the horizontal form-fill-seal methods commonly know in the art. A suitable method is described for example in WO 02/60758.

A suitable HFFS process to form the water-soluble liquid-containing pouches of the present invention is a continuous process comprising the steps of: (a) continuously feeding a first water-soluble film onto a horizontal portion of a continuously and rotatably moving endless surface, which comprises a plurality of moulds; (b) forming from the film on the horizontal portion of the continuously moving surface, and in the moulds on the surface, a continuously moving, horizontally positioned web of open pouches, by application of a vacuum through the bottom of the moulds onto the film; (c) filling the continuously moving, horizontally positioned web of open pouches with a liquid, to obtain a horizontally positioned web of open, filled pouches; (d) continuously closing the web of open pouches, to obtain closed pouches, by feeding a second water-soluble film onto the horizontally positioned web of open, filed pouches; and (e) heat sealing the closed pouches.

Alternatively, step (e) above may be performed by solvent welding (as described in WO 03/008486), and solvent or wet sealing.

While using a vacuum formed, horizontal form-fill-seal process, the first water-soluble film will typically have a thickness of from 20 μm to 100 μm before thermoforming.

It has been surprisingly found that when water-soluble pouches containing a liquid composition comprising from 5% to 15%, preferably from 6% to 12%, more preferably from 7% to 10%, most preferably from 8% to 10% by weight of the liquid composition of water and comprising at least one dissolved ionic component selected from the group consisting of carboxylates, phosphonates and mixtures thereof, are processed using a vacuum formed, horizontal form-fill-seal process, significantly improved water solubility of the liquid-containing pouch upon storage is obtained.

Enhanced water-solubility of the pouches according to the present invention is clearly observed over similar pouches manufactured using alternative pouch-producing methods commonly know in the art, such as for example vertical form-fill-seal process. The improvement in water solubility is particularly noticeable after several weeks storage of the liquid-containing pouch.

Preferred Optional Ingredients of the Liquid Composition

Highly preferred optional ingredients of the liquid composition are metal salts. Without being bound by any theory, it is believed that such metal salts further contribute in obtaining stable dissolution of the ionic components into the liquid composition contained within the water-soluble pouches according to the invention. Preferably, metals salts are selected from the group of magnesium salts and calcium salts. Particularly preferred salts are magnesium chloride, magnesium sulphate, magnesium sulfite and magnesium bisulfite. Magnesium chloride is a highly preferred salt in the context of the present invention. However the Applicant has found that chloride ions, especially at high temperatures, can have long term detrimental effects on the manufacturing equipment. In this case the most preferred metal salt is magnesium bisulfite. The use of magnesium bisulfite brings further advantages as well. Potassium sulfite provides a known benefit of improving the aesthetics of a composition upon ageing. The use of magnesium bisulfite, allows the detergent manufacturer to gain two benefits from one ingredient. Magnesium stabilizes the dissolved ionic component and the bisulfite provides the aesthetic benefit described above:

Preferably, the liquid composition comprises less than about 1%, more preferably less than 0.5%, most preferably less than 0.3% by weight of the composition, of the metal salts.

If the liquid composition is a detergent composition, it is preferred that at least a surfactant and/or a builder be present, preferably at least an anionic surfactant and preferably also a nonionic surfactant, and preferably at least a builder, more preferably at least a water-soluble builder such as phosphate builder and/or fatty acid builder. Other preferred components are enzymes and/or bleaching agents, such as a preformed peroxyacid.

Other preferred optional ingredients are also perfume, brightener, buffering agents, fabric softening agents, including clays and silicones, benefit agents, and suds suppressors.

In hard-surface cleaning compositions and dish wash compositions, it is preferred that at least a water-soluble builder is present, such as a phosphate, and preferably also surfactant, perfume, enzymes, bleach.

In fabric enhancing compositions, preferably at least a perfume and a fabric benefit agent are present for example a cationic softening agent, silicone softening agent or clay softening agent, anti-wrinkling agent, fabric substantive dye.

Other highly preferred optional ingredients in all above compositions are also solvents, such as alcohols, diols, monoamine derivatives, glycerol, glycols, polyalkylane glycols, such as polyethylene glycol, propane diol, monoethanolamine. Highly preferred are mixtures of solvents, such as mixtures of alcohols, or mixtures of diols and alcohols. Highly preferred may be that (at least) an alcohol, a diol, or monoethanolamine and preferably even glycerol be present in the composition. The compositions of the invention are preferably concentrated liquids having preferably less than 50% or even less than 40% by weight of solvent (other than water), preferably less than 30% or even less than 20% by weight of solvent (other than water). Preferably the solvent is present at a level of at least 5% or even at least 10% or even at least 15% by weight of the composition.

Highly preferred is that the composition comprises a plasticiser for the water-soluble pouch material, for example one of the plasticisers described above, for example glycerol. Such plasticisers can have the dual purpose of being a solvent for the other ingredients of the composition and a plasticiser for the pouch material.

Further highly preferred ingredients are other ionic ingredients selected from the group of polycarboxylated polymers (such as polyacrylic acid, polyacrylic-maleic acid copolymers), cationic ethoxylated amines, zwiterrionic polymers (such as those described in EP patent application No. 04447256), anionic soil release polymers.

In another embodiment of the present invention, it is provided a process for making a water-soluble pouch having improved water-solubility upon storage, comprising the steps of (a) formulating a liquid composition comprising at least one dissolved ionic component selected from the group consisting of carboxylates, phosphonates and mixtures thereof, and from 5% to 15% by weight of the liquid composition of water, and (b) processing a film comprising a co-polymer of vinyl alcohol and a carboxylic acid into a water-soluble pouch containing said liquid composition, using a vacuum formed, horizontal form-fill-seal process.

### Test Method

Polymer Residue Grading Test

In order to assess the in-wash solubility of liquid detergent pouches, the so-called “Black Pouch Solubility Method” has been developed. The method provides a relative assessment of the solubility of liquid detergent pouches under specified consumer relevant conditions. Data are generated by visual grading of PVA residues, relative to a defined grading scale.

Equipment needed: 4 Miele washing machines type W467, connected to a water temperature control system and 16 black velvet pouches made by folding and stitching a piece of black velvet (23.5×47 cm) with the velvet on the inside. The fabric used is Black Cotton Pie Velvet, quality 8897, commercially available from Denholme Velvets, Denholme, England.

Preparation of the Test: Liquid detergent-containing PVA pouches (at recommended dosage for normal conditions) are added, in a standardized way, inside the black velvet pouches. The resulting black pouches are thereafter closed by stitching. Each of the 4 washing machines is loaded with 4 black pouches in a standardized way. Different liquid detergent pouches may be added into a single washing machine, however at least 4 external replicates for each of the products are needed.

Test conditions: wool wash program at 40° C., using city water of 14° C.+/−1° C. via the water temperature control system.

Visual grading: At the end of the washing cycle, the black pouches are opened and visual grading of the polymer residues on fabric is immediately performed by at least 2 persons, according to a pre-defined grading scale. The overall grade is a statistical average of the different replicates. The grading scale ranges from 0, meaning no noticeable PVA residues on fabric after the wash, to 7, meaning that substantially no PVA pouch is noticeably dissolved. In the context of the present test, good pouch dissolution is obtained for a score below 3. A score of 3 means that no opaque PVA residues with a largest average diameter greater than 2 cm are visible on fabric after the wash. Ideally, the score should be as low as possible.

### EXAMPLES

The following examples will further illustrate the present invention. The compositions are made by combining the listed ingredients in the listed proportions (weight % unless otherwise specified). Example compositions 1 to 4 are meant to exemplify compositions according to the present invention but are not necessarily used to limit or otherwise define the scope of the present invention.

| Ingredients: | | | | |
|---|---|---|---|---|
| (% by weight) | 1 | 2 | 3 | 4 |
| Dodecylbenzene | 21 | 23 | 19 | 25 |
| sulphonic acid | | | | |
| C12-14 alcohol, 7x | 21 | 19 | 22 | 18 |
| ethoxylated | | | | |
| C8-C10 amido propyl | 1.1 | — | — | — |
| dimethylamine | | | | |
| Citric acid | 1.7 | 2.0 | — | 1.7 |
| C12-C18 alkyl fatty | 14 | 15 | 18 | 14 |
| acid | | | | |
| Hydroxyethane | 0.75 | 0.45 | 0.90 | — |
| diphosphonic acid | | | | |
| Diethylene Triamine | — | — | — | 0.41 |
| Penta methylene | | | | |
| phosponic acid | | | | |
| Protease/amylase | 1.6 | 1.6 | 1.6 | 1.6 |
| enzymes | | | | |
| Magnesium chloride | 0.10 | — | 0.11 | — |
| Potassium sulfite | 0.12 | 0.14 | 0.16 | — |
| Polyethyleneimine, | 1.3 | 1.3 | 1.6 | 1.3 |
| 20x ethoxylated | | | | |
| Zwitterionic | 2.5 | 1.2 | 2.8 | 2.5 |
| polyamine | | | | |
| Optical brightener | 0.22 | 0.21 | 0.22 | 0.19 |
| Hydrogenated castor | 0.21 | 0.20 | 0.21 | — |
| oil | | | | |
| Propylene Glycol | 4.0 | 5.2 | 7.0 | 15 |
| Glycerine | 9.5 | 7.5 | 7.5 | — |
| Polydimethylsiloxane | — | 2.0 | — | — |
| Monoethanolamine | 9.8 | 10.7 | 9.0 | 10.6 |
| Perfume, dyes, | 2.4 | 2.4 | 2.4 | 2.2 |
| minors, Sodium | | | | |
| hydroxide | | | | |
| Water | 8.7 | 8.1 | 7.5 | 7.5 |

Dodecylbenzene sulphonic acid is commercially available from Ifrachem.
C12-C14 alcohol, 7x ethoxylated is commercially available from Sasol.
C8-C10 amido propyl dimethylamine is commercially available from Akzo Nobel chemicals LTD.
Citric acid is commercially available from Citrique Belge NV.
C12-C18 alkyl fatty acid is commercially available from Akzo Nobel Chem. GMBH.
Hydroxyethane diphosphonic acid is commercially available from Solutia Europe NV.
Diethylene Triamine Penta methylene phosponic acid is commercially available from Albright & Wilson LTD.
Enzymes are proteolitic and amylolytic enzyme solutions commercially available from respectively Genencor and Novozymes.
Magnesium chloride is commercially available from Nedmag.
Potassium sulfite is commercially available from BASF.
Polyethyleneimine ethoxylate PEI600 E20, is commercially available from BASF.
Zwitterionic polyamine is Lutensit Z96 ™, commercially available from BASF.
Optical brightener is disodium 4,4′-bis-(2-sulphostyryl) biphenyl, commercially available from Ciba AG.
Hydrogenated castor oil is commercially available from Brasil Oleo De Mamona.
Propylene Glycol is commercially available from BASF.
Glycerine is commercially available from NAT OLEO.
Polydimethylsiloxane is commercially available from Dow Corning.
Monoethanolamine is commercially available from Sasol.

The liquid compositions 1, 2, 3 and 4 were packed into film pouches using vacuum-formed, horizontal form-fill-seal process, each pouch containing about 50 ml of liquid. The film was made from a polyvinyl alcohol/carboxylate copolymer resin (M8630™, Mono-Sol, Indiana, US). The resulting pouches comprise completely homogeneous liquids. The dissolution and disintegration profiles of each of the pouched compositions is good; the pouches dissolve/disintegrate rapidly in water without leaving any residue even after prolonged storage (eight weeks) at 35° C.

### Comparative Data

The following examples will further illustrate the present invention. The compositions are made by combining the listed ingredients in the listed proportions (weight % unless otherwise specified). Example compositions 5 and 6 are meant to exemplify compositions according to the present invention but are not necessarily used to limit or otherwise define the scope of the present invention. Example compositions A, B, and C are comparative examples.

| Ingredients: | | | | |
|---|---|---|---|---|
| (% by weight) | 5 | A | B | 6/C |
| Dodecylbenzene | 24 | 23 | 20 | 21.8 |
| sulphonic acid | | | | |
| C12-14 alcohol, 7x | 19 | 19 | 20 | 18.5 |
| ethoxylated | | | | |
| C8-C10 amido | — | 1.9 | 1.6 | 1.7 |
| propyl dimethylamine | | | | |
| Citric acid | 1.7 | 1.7 | 0.67 | 1.5 |
| C12-C18 alkyl fatty | 14 | 17 | 6.4 | 16.4 |
| acid | | | | |
| Hydroxyethane | 0.74 | 0.84 | 1.8 | — |
| diphosphonic acid | | | | |
| Diethylene Triamine | — | — | 0.46 | 0.85 |
| Penta methylene | | | | |
| phosponic acid | | | | |
| Protease/amylase | 1.6 | 1.5 | — | 1.5 |
| Enzymes | | | | |
| Magnesium chloride | 0.10 | — | 0.10 | — |
| Potassium sulfite | 0.15 | — | 0.15 | — |
| Polyethyleneimine, | 1.3 | 1.6 | — | 1.5 |
| 20x ethoxylated | | | | |
| Formic acid | — | — | 0.17 | 1.1 |
| Ethoxylated | | 1.6 | — | 1.5 |
| tetraethylene | | | | |
| pentamine | | | | |
| Zwitterionic | 2.8 | — | 2.7 | — |
| polyamine | | | | |
| Optical brightener¹ | 0.21 | 0.26 | 0.17 | 0.25 |
| Hydrogenated castor | 0.20 | — | 0.18 | — |
| oil | | | | |
| Propylene Glycol | 6.3 | 17 | 16 | 15 |
| Glycerine | 7.5 | — | — | — |
| Monoethanolamine | 10.2 | 8 | 7.3 | 11.4 |
| Perfume, dyes, | 2.4 | 3.5 | 4.8 | 1.7 |
| minors, Na-hydroxide | | | | |
| Water | 7.8 | 3.1 | 17.5 | 5.3 |

Formic acid is commercially available from BASF.
Ethoxylated tetraethylene pentamine is commercially available from BASF.
Optical brightener is disodium 4,4′-bis-(2-sulphostyryl) biphenyl, commercially available as from Ciba AG, in compositions 5 and B and is a disulphated di-amino stilbene based fluorescent whitening agent, commercially available from Hickson & Welch LTD, in compositions 6, A and C.

Experiment 1: Effect of the Water Content of the Liquid Composition on Physical Stability and Solubility of Various PVA Pouches after Storage.

The liquid compositions 5, A, and B were packed into film pouches using vacuum-formed, horizontal form-fill-seal process, each pouch containing about 50 ml of liquid. The film was made from a polyvinyl alcohol/carboxylate copolymer resin (sold under the trade reference M8630™ by Mono-Sol of Indiana, US). The corresponding pouches were stored for 8 weeks at 35° C.

The physical stability after storage has been assessed by visual observation of the corresponding pouches. The in-wash solubility of the liquid-containing pouches has been assessed using the “Black Pouch Solubility Method” as described herein above.

Results are presented in the table below.

| | Pouched | Pouched | Pouched |
|---|---|---|---|
| | composition 5 | composition A | composition B |
| Physical | Translucent, | Solid precipitate of | Translucent, |
| stability | homogeneous | HEDP present | Homogeneous |
| Black pouch | 1.5 (good | n.a. | 3.6 (poor |
| solubility score | solubility) | | solubility) |

The above results clearly show the improved physical stability and solubility after storage of a water-soluble pouch according to the present invention (pouched composition 5), versus comparative water-soluble pouches (pouched compositions A and B).

Experiment 2: Effect of the Water-Soluble Pouch Manufacturing Process on the In-Wash Solubility of the Liquid-Containing Pouches after Storage.

Liquid compositions 6 and C have the same chemical composition but were packed into two different types of film pouches, both containing about 50 ml of liquid composition but processed using two different manufacturing processes. A first set of pouches was manufactured using vacuum-formed, horizontal form-fill-seal process (HFFS) (pouched composition 6), and a second set of pouches was manufactured using vertical form-fill-seal process (VFFS) (pouched composition C). The films were made from a polyvinyl alcohol/carboxylate copolymer resin (commercially available under tradename M8630™ from Mono-Sol of Indiana, US). The corresponding pouches were stored for 10 months at room temperature. The in-wash solubility of the liquid-containing pouches has been assessed using the “Black Pouch Solubility Method” as described herein above.

Results are presented in the table below.

| | Composition 6 | Composition C |
|---|---|---|
| | pouched via | pouched via |
| | HFFS | VFFS |
| Black pouch | 1.0 (good | 3.0 (poor |
| solubility score | solubility) | solubility) |

The above results clearly show the improved solubility after storage of a water-soluble pouch according to the present invention, i.e. processed using vacuum-formed, horizontal form-fill-seal process (pouched composition 6), when compared to a water-soluble pouch not according to the invention (pouched composition C).

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble pouch containing a liquid composition wherein the water-soluble pouch is made from a film comprising a co-polymer of vinyl alcohol and a carboxylic acid, wherein the liquid composition contained within said pouch comprises at least one dissolved ionic component selected from the group consisting of carboxylates, phosphonates and mixtures thereof, characterized in that said liquid composition comprises from about 5% to about 15% by weight of the liquid composition of water, and said pouch is processed using a vacuum formed, horizontal form-fill-seal process.

2. A water-soluble pouch according to claim 1 wherein said at least one ionic component is a phosphonate.

3. A water-soluble pouch according to claim 1 wherein said at least one ionic component is hydroxy-ethylene 1,1 diphosphonate.

4. A water-soluble pouch according to claim 1 wherein said liquid composition comprises from about 6% to about 12%, preferably from about 7% to about 10%, more preferably from about 8% to about 10% by weight of the liquid composition, of water.

5. A water-soluble pouch according to claim 1 wherein said liquid composition comprises from about 0.2% to about 4.0%, preferably from about 0.5% to about 3.0%, more preferably from about 0.5% to about 2.0% by weight of the liquid composition, of said at least one ionic component.

6. A water-soluble pouch according to claim 1 wherein said liquid composition further comprises metal salts selected from magnesium salts and calcium salts, preferably from magnesium salts.

7. A water-soluble pouch according to claim 6 wherein said metal salt is selected from magnesium chloride, magnesium bisulfite or mixtures thereof

8. A water-soluble pouch according to claim 6 wherein said liquid composition comprises less than about 1%, preferably less than about 0.5%, more preferably less than about 0.3% by weight of the liquid composition, of said metal salts.

9. A water-soluble pouch according to claim 1 wherein said liquid composition further comprises one or more ingredients selected from the group of polycarboxylic acids, polycarboxylate salts, polyphosphonic acids, polyphosphonate salts, cationic ethoxylated amines, zwitterionic polymers, enzymes, and mixtures thereof.

10. A water-soluble pouch according to claim 1 wherein said pouch following storage of 8 weeks at 35° C. exhibit water-solubility according to the “Black Pouch Solubility Method” such that no film residues with a largest average diameter of greater than about 2 cm are visible on the fabric after washing.

11. A process of making a water-soluble pouch having improved water-solubility upon storage, wherein said process comprises the steps of:
(a) formulating a liquid composition comprising at least one dissolved ionic component selected from the group consisting of carboxylates, phosphonates and mixtures thereof, and from about 5% to about 15% by weight of the liquid composition of water;
(b) processing a film comprising a co-polymer of vinyl alcohol and a carboxylic acid into a water-soluble pouch containing said liquid composition, using a vacuum formed, horizontal form-fill-seal process.
